(19) United States
(12) Patent Application Publication
(10) Pub. No.: US 2019/0205833 A1
(43) Pub. Date: Jul. 4, 2019

(54) BILL OF MATERIAL BASED PREDECESSOR PRODUCT DETERMINATION IN DEMAND PLANNING

(71) Applicant: SAP SE, Walldorf (DE)

(72) Inventors: Zoltan Miklos Biro, Gyomro (HU); Aniko Bartok, Balatonvilagos (HU); Ferencz Zsolt Sipos, Budapest (HU); Nikoletta Sarkany, Budapest (HU); Roland Horvath, Gyor (HU); Mihaly Ducz, Budapest (HU); Tamas Krasznai, Budapest (HU); Norbert Kopasz, Tiszavasvari (HU); Gabor Mittweg, Budapest (HU)

(21) Appl. No.: 15/857,818

(22) Filed: Dec. 29, 2017

(51) Int. Cl. G06Q 10/08; G06Q 10/06

(52) U.S. Cl. CPC G06Q 10/0875; G06Q 10/06315

(57) ABSTRACT

Implementations of the present disclosure include methods, systems, and computer-readable storage mediums for receiving a plurality of bills of material (BOMs), each BOM including a data structure defining items within a respective product, enhancing each BOM based on one or more attributes to provide enhanced BOMs, clustering the enhanced BOMs into two or more clusters, determining a matching cluster from the two or more clusters at least partially based on a BOM of a new product introduction (NPI), selecting a sub-set of predecessor products from the matching cluster, and providing the sub-set of predecessor products as the one or more recommended predecessor products for selection by a user.

### BACKGROUND

Demand planning in supply chains is an increasingly complex, and resource intensive task. There are multiple changes that are taking place in modern supply chains, such as an increase of the number of products offered by manufacturing companies, shorter product lifecycles, and an increased demand for more personalized products. In demand planning, demand for new products is forecast based on demand of predecessor products, and/or similar products from the past.

In a controlled phase-in/phase-out scenario, a predecessor product is gradually phased out, while a successor product is phased in. Both products are planned, and consecutively produced. In the case of wholly new products, referred to as new product introductions, there is no predecessor product that can be used for demand forecasting of the new product. That is, without a predecessor product, the new product cannot be forecast based on historical demand, as it has no history of its own.

As the number of new product launches increases, it is increasingly difficult to determine, and manage all product successions. For example, a demand planner is responsible for many hundreds of product-specific codes (e.g., stock keeping units (SKUs)) on a single market, and even multiple markets over several countries. The demand planner needs to know the entire product range in detail, in order to be able to decide on product successions on all markets, and product ranges or brands.

### SUMMARY

Implementations of the present disclosure include computer-implemented methods for demand planning. More particularly, implementations of the present disclosure provide a demand planning platform that identifies predecessor products based on bills of material (BOMs).

In some implementations, actions include receiving a plurality of bills of material (BOMs), each BOM including a data structure defining items within a respective product, enhancing each BOM based on one or more attributes to provide enhanced BOMs, clustering the enhanced BOMs into two or more clusters, determining a matching cluster from the two or more clusters at least partially based on a BOM of a new product introduction (NPI), selecting a sub-set of predecessor products from the matching cluster, and providing the sub-set of predecessor products as the one or more recommended predecessor products for selection by a user. Other implementations include corresponding systems, apparatus, and computer programs, configured to perform the actions of the methods, encoded on computer storage devices.

These and other implementations may each optionally include one or more of the following features: clustering includes providing representations of each enhanced BOM as a multi-dimensional vector, and processing the multi-dimensional vectors using a classification algorithm to provide the two or more clusters; determining a matching cluster includes determining a cluster center for each cluster, and comparing cluster centers to the NPI at least partially based on the BOM of the NPI; selecting a sub-set of predecessor products comprises at least one of determining similarities between predecessor products of the sub-set of predecessor products and the NIP, and applying one or more filters to predecessor products of the sub-set of predecessor products; the NPI includes a product that is without a predecessor product; the items include one or more of raw materials, sub-assemblies, intermediate assemblies, sub-components, and parts, and quantities of each needed to manufacture a finished product represented by a respective BOM; and the attributes include one or more of brand, product group, product family.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIGS. 2A-2C depict conceptual diagrams for providing one or more suggested predecessor products in accordance with implementations of the present disclosure.

FIG. 3 depicts an example user interface in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure include computer-implemented methods for demand planning. More particularly, implementations of the present disclosure provide a demand planning platform that identifies predecessor products based on bills of materials (BOMs). In accordance with implementations of the present disclosure, and as described in further detail herein, actions can include receiving a plurality of BOMs, each BOM including a data structure defining items within a respective product, enhancing each BOM based on one or more attributes to provide enhanced BOMs, clustering the enhanced BOMs into two or more clusters, determining a matching cluster from the two or more clusters at least partially based on a BOM of a new product introduction (NPI), selecting a sub-set of predecessor products from the matching cluster, and providing the sub-set of predecessor products as the one or more recommended predecessor products for selection by a user.

To provide further context for implementations of the present disclosure, and as introduced above, demand planning for new products can be time, and resource intensive. In some examples, a demand planner is responsible for the demand plan of several product groups in a region (e.g., geographical area), or multiple regions. Demand planning strives to achieve as high of a forecast accuracy as possible, while accounting for a large number of products. This includes wholly new product launches. Demand planning can include collaboration with sales and marketing in order to understand the reason for the differences in the number that the demand planner forecasted versus the sales or marketing forecast. Demand planning also seeks opportunities to improve the forecast accuracy.

Traditional demand planning approaches, however, heavily rely on the demand planners' knowledge of previous products. In many markets, the number of products increases each year, resulting in a significant number of NPIs year-after-year. Further, more frequent innovation, shorter product lifecycles, and demands for more personalized products results in an increased number of products year-after-year. Consequently, the amount of product data has significantly increased, and continues to increase, making demand planning an arduous task.

In view of the foregoing, implementations of the present disclosure provide a demand planning platform that identifies one or more reference products for an NPI (i.e., a new product that does not have a predecessor product associated therewith). More particularly, and as described herein, the demand planning platform of the present disclosure processes a BOM of the NPI in view of BOMs of predecessor products, and automatically identifies the one or more predecessor products for recommendation. In some examples, a BOM can be described as a formally structured list of items that make up a product. The BOM includes a unique object number for each item, as well as the quantity and unit of measure of the component. In some examples, a complex product has a BOM that includes raw materials and one or more semi-finished goods. All of this results in a complex BOM structure that is to be explored in the demand planning processes.

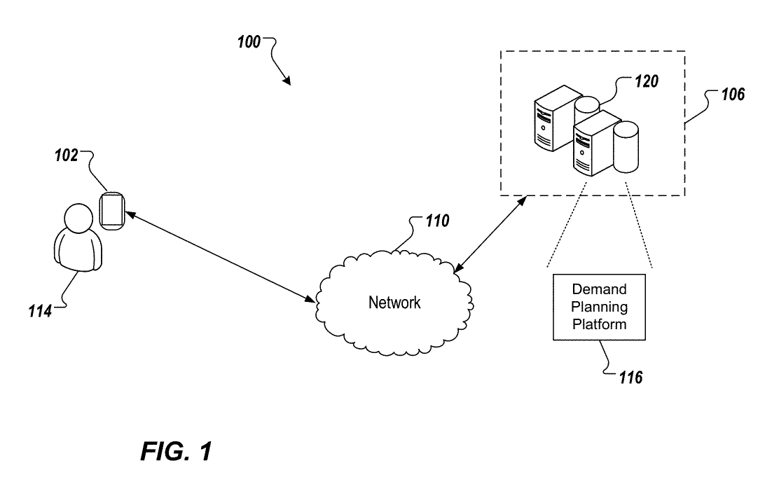

FIG. 1 depicts an example environment 100 that can be used to execute implementations of the present disclosure. In some examples, the example environment 100 enables one or more predecessor products to be recommended to a demand planner. The example environment 100 includes a computing device 102, a back-end system 106, and a network 110. In some examples, the computing device 102 is used by a user 114 (e.g., a demand planner) to request, and receive recommended predecessor products. For example, the user 114 can use the computing device 102 to input a BOM of a new product, and to receive one or more recommended predecessor products in response.

In the depicted example, the computing device 102 is provided as a mobile computing device. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing device 102), and back-end systems (e.g., the back-end system 106). In some examples, the network 110 can be accessed over a wired and/or a wireless communications link. For example, mobile computing devices, such as smartphones can utilize a cellular network to access the network 110.

In the depicted example, the back-end system 106 includes at least one server system 120. In some examples, the at least one server system 120 hosts one or more computer-implemented services. For example, the back-end system 106 can host a computer-implemented demand planning platform 116 in accordance with implementations of the present disclosure. In some examples, the demand planning platform 116 can be a stand-alone system. In some examples, the demand planning platform 116 can be part of a higher-level planning platform (e.g., SAP Integrated Business Planning provided by SAP SE of Walldorf, Germany).

In some examples, the computing device 102 includes a computer-executable application executed thereon, which can be used to interact with the demand planning platform 116, as described herein. In some examples, the computing device 102 includes a web browser application executed thereon, which can be used to display one or more web pages for interaction with the demand planning platform 116, as described herein.

In some implementations, the demand planning platform 116 of the present disclosure receives all BOMs for all finished goods produced in the past (e.g., by a particular enterprise). For example, the demand planning platform 116 receives BOMs as computer-readable data structures from a BOM database. In some implementations, the demand planning platform 116 uses the BOMs, and one or more attributes of the respective product to cluster the predecessor products into groups. Example attributes can include, without limitation, brand, product group, product family.

In some examples, a BOM is computer-readable data structure that encodes a list of items that make-up a finished product. Example items include, without limitation, raw materials, sub-assemblies, intermediate assemblies, sub-components, and parts, and quantities of each needed to manufacture the finished product. In some examples, the BOM includes a hierarchy, beginning with the finished product (e.g., a root node) at the highest level, and raw materials, sub-assemblies, intermediate assemblies, sub-components, and parts (e.g., child nodes, leaf nodes) at lower levels. In some examples, each node includes in identifier uniquely identifying a respective item, and a quantity in relevant units (e.g., number, weight, volume) of the item.

In some implementations, the demand planning platform 116 executes a classification algorithm to group products that are determined to be similar based on their respective BOMs, and attributes. In some examples, the input variables for classification can include categorical variables (e.g., brand that has values like Brand X, Brand Y), and/or continuous variables (e.g., component quantity (to produce a particular hair dryer exactly one electric motor is required). In some examples, categorical variables are transformed into dichotomy variables to enable processing through the classification algorithm. For example, a product group variable can include one of multiple values. Example values can include ice creams, cookies, and sauces. Accordingly, the product group is a categorical variable, which, in this example, is split into three (3) different dichotomy variables (ice creams, cookies, sauces) that each will be assigned only one of two values (e.g., 0 and 1). For a product belonging to the cookies product group, the following values for the transformed dichotomy variables are provided as 010 (i.e., ice creams=0; cookies=1; sauces=0). For similar products, groups (clusters) are formed. These groups are distinguishable from one another, and are used to identify example predecessor products for NPIs, as described in further detail herein.

In some implementations, each product is represented as a multi-dimensional vector based on its respective BOM, and attributes. The multi-dimensional vectors are processed by the classification algorithm to determine similarity between products. Example classification algorithms include, without limitation, K-means clustering, Fuzzy C-means clustering, Hierarchical clustering, and Mixture of Gaussians clustering. Any appropriate classification algorithm can be used. In some implementations, the classification algorithm determines a metric that is representative of a similarity between two products, the metric representing a degree of difference between the respective multi-dimensional vectors. In some examples, if the metric is below a threshold, the products represented by the multi-dimensional vectors are determined to be sufficiently similar to be grouped together in a cluster.

In some examples, the metric includes a distance (e.g., Euclidean distance) between the multi-dimensional vectors. A distance can be used for products having relatively low complexity (e.g., multi-dimensional vectors of relatively low dimensions), and can be resource-efficient, in terms of processing power expended to calculate the metric across the entirety of the products. In some examples, the metric includes the Minkowski metric, which can be used for products having relatively high complexity (e.g., multi-dimensional vectors of relatively high dimensions). Using the Minkowski metric may be more resource-burdensome, but can provide improved clustering accuracy for complex products. Although example metrics are provided herein, any appropriate metric can be used with implementations of the present disclosure.

In some implementations, for an NPI, the demand planning platform identifies a group (the identified group, or matching cluster) that the NPI is either in, or is most similar to. In some examples, a cluster center is determined. For example, a product within each group is identified as the cluster center. In some examples, the product having the lowest metric (e.g., distance, Minkowski metric) between all other products in the cluster is identified as the cluster center. In another example, a theoretical product within each group is identified as the cluster center. In some examples, the theoretical product is determined to be a product that, if real, would have the lowest metric (e.g., distance, Minkowski metric) between all other products in the cluster.

In some implementations, a multi-dimensional vector representing the NPI is compared to the cluster centers to determine the cluster that the NPI is closest to. In some examples, a classification model used to determine the closest matching cluster. An example classification model can include, without limitation, a nearest centroid classification algorithm (e.g., Rocchio classifier, K Nearest Neighbor (KNN)). In some examples, a metric is determined between the NPI, and each cluster center, and the cluster of the cluster center with the lowest metric is determined to be the matching cluster.

The products in the matching cluster are candidates for similar, predecessor products that can be recommended. In some examples, one or more products are selected from the matching cluster based on respective metrics. For example, a metric is determined between the NPI, and each product in the matching cluster. In some examples, a threshold metric is provided, and any product having a metric that is lower than the threshold is provided as a recommended product. In some examples, a BOM match score can be determined that represents the overlap in BOMs of the new product, and a respective product within the matching cluster. In some examples, a threshold BOM match score can be provided, and products of the matching cluster having a BOM match score exceeding the threshold BOM match score are provided as recommended products.

In some implementations, the user can select a predecessor product from the one or more recommended predecessor products, and historical data regarding the selected predecessor product can be provided. Example historical data can include a quantity (e.g., number of sales) of the predecessor product in one or more time periods (e.g., past months, quarters, years). Example historical data can also include a product mix, within which the predecessor product was sold. That is, for example, the selected predecessor product may have been part of a product mix including one or more other predecessor products. In some examples, a product mix can be provided in terms of percentages of respective products with respect to a total for the given time period.

In some implementations, a weight can be applied to the quantity of the selected predecessor product based on a previous product mix, and a current product mix. For example, the predecessor product may have been part of a product mix including one or more other predecessor products. In some examples, if the current product mix is consistent with the previous product mix, the weight can be provided as a first value. For example, the weight can be provided as 1, resulting in the relative quantity of the NPI being the same as previously provided for the selected predecessor product. In some examples, if the current product mix is not consistent with the previous product mix, the weight can be provided as a second value. For example, the weight can be provided as less than, or greater than 1, resulting in the relative quantity of the NPI being the different (e.g., less, or more) as previously provided for the selected predecessor product.

By way of non-limiting example, a NPI (PROD_NEW) can have two known predecessor products: PROD_OLD_1 and PROD_OLD_2. In this example, the predecessor products were sold in a succession: PROD_OLD_1 was sold first, then it was replaced by PROD_OLD_2. Now, in turn, PROD_OLD_@ will be replaced by PROD_NEW. Continuing with this example, PROD_OLD_2 was a more successful product than PROD_OLD_1, and increased its share from total sales of the product group from 20% achieved by PROD_OLD_1 to 40%. For simplicity, this example assumes that the sales for the complete product group was and remains constant. The estimation is that PROD_NEW will have the same market success as PROD_OLD_2. This means that, while the weight of PROD_OLD_2 is set to 1, the weight of PROD_OLD_1 needs to be set to 2, so that the actual sales achieved by PROD_OLD_1 is adjusted to the same level of success that was present when PROD_OLD_2 was sold. In this manner, the weighted combined history is used when generating a forecast for PROD_NEW.

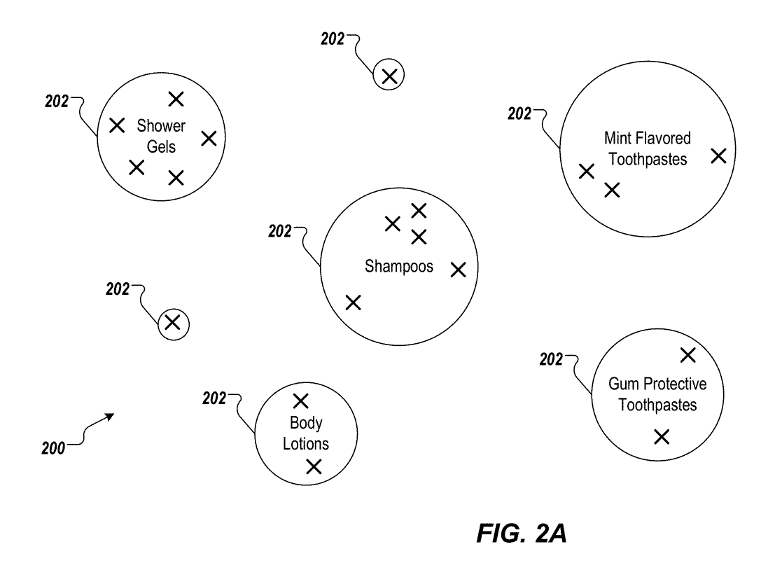

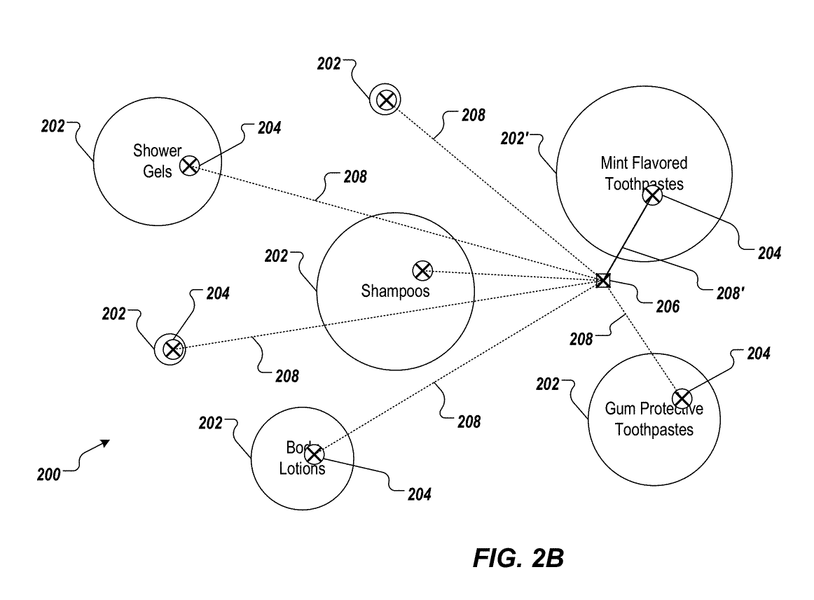

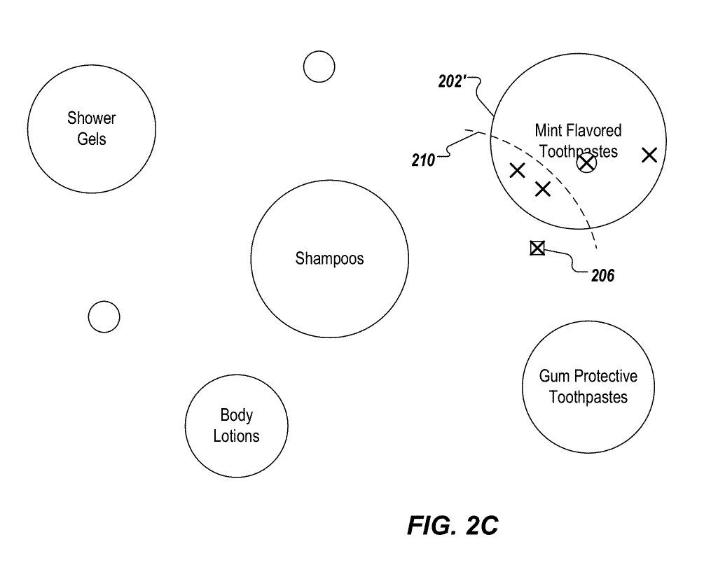

FIGS. 2A-2C depict conceptual diagrams 200 for providing one or more suggested predecessor products in accordance with implementations of the present disclosure. The example depicted in FIGS. 2A-2C includes a NPI, for which one or more predecessor products are to be recommended. In this example, twenty (20) predecessor products were sold in the past (e.g., by an enterprise), all of them being personal healthcare items (e.g., shower gels, soaps, body lotions, toothpastes). Although twenty predecessor products are provided in this example, it is appreciated that predecessor products can number in the hundreds, and thousands. For each of the predecessor products, a respective BOM is retrieved (e.g., from a database), and attributes are received (e.g., from the database), and a multi-dimensional vector is provided. The products are processed relative to one another by a clustering algorithm, and a plurality of clusters 202 are provided, as described herein. In FIG. 2A, the conceptual diagram 200 includes the clusters 202, of which some have been labelled for ease of understanding the instant discussion. Each predecessor product is graphically depicted as an X.

With particular reference to FIG. 2B, a cluster center 204 is determined for each cluster 202, as described herein. A representation (e.g., multi-dimensional vector) is provided for a NPI 206, and is compared to each of the cluster centers 204 to determine a metric between each. In the depicted example, the metric includes a distance 208, and a distance 208′ is the shortest. Consequently, the cluster 202′ is determined to be most similar to the NPI 206, and is provided as the matching cluster.

With particular reference to FIG. 2C, one or more predecessor products are selected as recommended predecessor products from the matching cluster 202′. In some implementations, recommended predecessor products can be selected based on similarities (e.g., BOM match scores, metrics), and/or filters. Examples filters include, without limitation, that the similarity score is above a threshold (e.g., 80%), only predecessor products sold in the last X years are used (e.g., X is an integer that is greater than 0), and the predecessor product includes a specific product attribute (e.g., flavor=peppermint). In the example of FIG. 2C, a boundary 210 graphically represents similarities, and/or filters that can be applied to select predecessor products from the matching cluster. In the depicted example, two predecessor products are within the boundary 210, and would therefore, be recommended predecessor products.

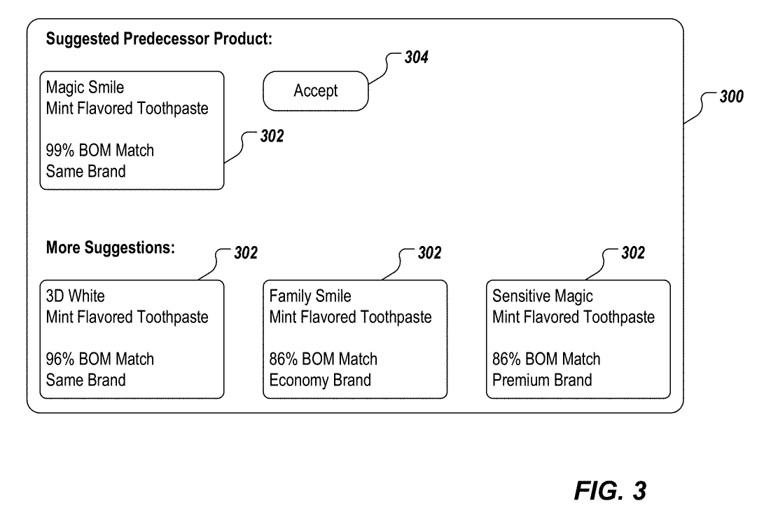

FIG. 3 depicts an example user interface 300 in accordance with implementations of the present disclosure. The example user interface 300 provides graphical representations 302 of one or more recommended predecessor products. In the example of FIG. 3, a first suggested product is provided (e.g., Magic Smile, Mint Flavored Toothpaste) as being the same brand as an NPI, for which a recommended predecessor product is sought, as well as having the highest overlap in BOM (e.g., 99%). Additional suggested products are also provided, which have lower overlaps in BOM than the first suggested product. In some examples, if the user is satisfied with the first suggested product, the user can select an accept button 304 to use historical information associated with the first suggested product in demand planning for the NPI. Otherwise, the user can select one of the additional suggested products.

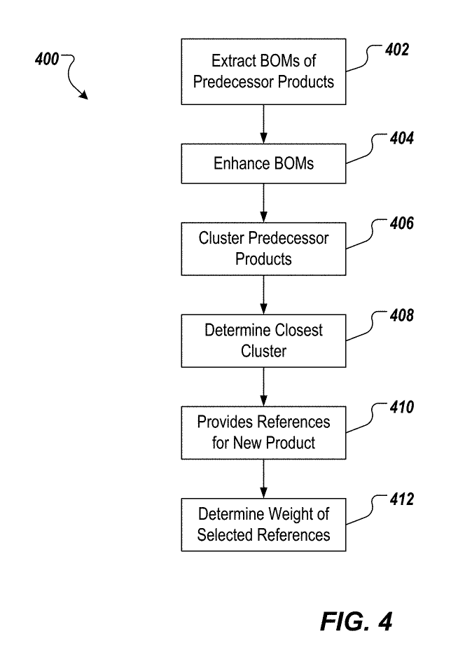

FIG. 4 depicts an example process 400 that can be executed in accordance with implementations of the present disclosure. In some implementations, the example process 400 may be performed using one or more computer-executable programs executed using one or more computing devices.

BOMs of predecessor products are extracted (402). For example, BOMs of all products previously, and/or currently provided by an enterprise are received from a database. The BOMs are enhanced (404). For example, each BOM is enhanced with one or more attributes to provide an enhanced BOM. Example attributes include, without limitation, brand, product group, product family. The predecessor products are clustered (406). For example, each enhanced BOM is represented as a multi-dimensional vector, and a classification algorithm processes the multi-dimensional vectors to cluster the predecessor products into groups, as described herein (e.g., see example of FIG. 2A).

A matching cluster is determined (408). For example, and as described herein, a cluster center is determined for each cluster, and each cluster center is compared to a multi-dimensional vector that represents the NPI. The cluster with the cluster center that most closely matches the NPI is selected as the matching cluster (e.g., see example of FIG. 2B). Suggested predecessor products are provided (410). For example, and as described herein, similarities can be determined, and/or filters applied to select a sub-set of predecessor products within the matching cluster (e.g., see example of FIG. 2C). The predecessor products within the sub-set of predecessor products are provided to a user as recommended predecessor products (e.g., see example of FIG. 3). A weight of the selected predecessor product is determined (412). For example, and as described herein, a weight can be determined based on a previous product mix, and a current product mix to selectively bias a quantity of the selected predecessor product for use with the NPI.

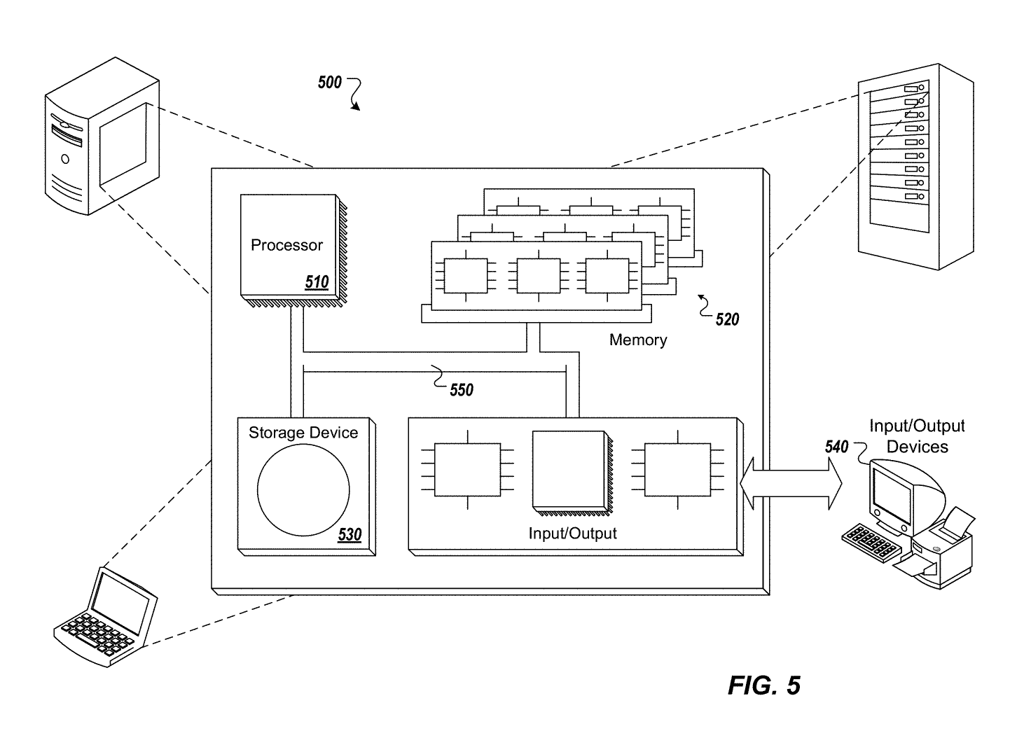

FIG. 5 depicts a schematic diagram of an example computing system 500. The system 500 may be used to perform the operations described with regard to one or more implementations of the present disclosure. For example, the system 500 may be included in any or all of the server components, or other computing device(s), discussed herein. The system 500 may include one or more processors 510, one or more memories 520, one or more storage devices 530, and one or more input/output (I/O) devices 540. The components 510, 520, 530, 540 may be interconnected using a system bus 550.

The processor 510 may be configured to execute instructions within the system 500. The processor 510 may include a single-threaded processor or a multi-threaded processor. The processor 510 may be configured to execute or otherwise process instructions stored in one or both of the memory 520 or the storage device 530. Execution of the instruction(s) may cause graphical information to be displayed or otherwise presented via a user interface on the I/O device 540.

The memory 520 may store information within the system 500. In some implementations, the memory 520 is a computer-readable medium. In some implementations, the memory 520 may include one or more volatile memory units. In some implementations, the memory 520 may include one or more non-volatile memory units.

The storage device 530 may be configured to provide mass storage for the system 500. In some implementations, the storage device 530 is a computer-readable medium. The storage device 530 may include a floppy disk device, a hard disk device, an optical disk device, a tape device, or other type of storage device. The I/O device 540 may provide I/O operations for the system 500. In some implementations, the I/O device 540 may include a keyboard, a pointing device, or other devices for data input. In some implementations, the I/O device 540 may include output devices such as a display unit for displaying graphical user interfaces or other types of user interfaces.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method executed by one or more processors for automatically identifying one or more recommended predecessor products for demand planning, the method comprising:
receiving, by the one or more processors, a plurality of bills of material (BOMs), each BOM comprising a data structure defining items within a respective product;
enhancing, by the one or more processors, each BOM based on one or more attributes to provide enhanced BOMs;
clustering, by the one or more processors, the enhanced BOMs into two or more clusters;
determining, by the one or more processors, a matching cluster from the two or more clusters at least partially based on a BOM of a new product introduction (NPI);
selecting, by the one or more processors, a sub-set of predecessor products from the matching cluster; and
providing, by the one or more processors, the sub-set of predecessor products as the one or more recommended predecessor products for selection by a user.

2. The method of claim 1, wherein clustering comprises providing representations of each enhanced BOM as a multi-dimensional vector, and processing the multi-dimensional vectors using a classification algorithm to provide the two or more clusters.

3. The method of claim 1, wherein determining a matching cluster comprises determining a cluster center for each cluster, and comparing cluster centers to the NPI at least partially based on the BOM of the NPI.

4. The method of claim 1, wherein selecting a sub-set of predecessor products comprises at least one of determining similarities between predecessor products of the sub-set of predecessor products and the NIP, and applying one or more filters to predecessor products of the sub-set of predecessor products.

5. The method of claim 1, wherein the NPI comprises a product that is without a predecessor product.

6. The method of claim 1, wherein the items comprise one or more of raw materials, sub-assemblies, intermediate assemblies, sub-components, and parts, and quantities of each needed to manufacture a finished product represented by a respective BOM.

7. The method of claim 1, wherein the attributes comprise one or more of brand, product group, product family.

8. A non-transitory computer-readable storage medium coupled to one or more processors and having instructions stored thereon which, when executed by the one or more processors, cause the one or more processors to perform operations for automatically identifying one or more recommended predecessor products for demand planning, the operations comprising:
receiving a plurality of bills of material (BOMs), each BOM comprising a data structure defining items within a respective product;
enhancing each BOM based on one or more attributes to provide enhanced BOMs;
clustering the enhanced BOMs into two or more clusters;
determining a matching cluster from the two or more clusters at least partially based on a BOM of a new product introduction (NPI);
selecting a sub-set of predecessor products from the matching cluster; and
providing the sub-set of predecessor products as the one or more recommended predecessor products for selection by a user.

9. The computer-readable storage medium of claim 8, wherein clustering comprises providing representations of each enhanced BOM as a multi-dimensional vector, and processing the multi-dimensional vectors using a classification algorithm to provide the two or more clusters.

10. The computer-readable storage medium of claim 8, wherein determining a matching cluster comprises determining a cluster center for each cluster, and comparing cluster centers to the NPI at least partially based on the BOM of the NPI.

11. The computer-readable storage medium of claim 8, wherein selecting a sub-set of predecessor products comprises at least one of determining similarities between predecessor products of the sub-set of predecessor products and the NIP, and applying one or more filters to predecessor products of the sub-set of predecessor products.

12. The computer-readable storage medium of claim 8, wherein the NPI comprises a product that is without a predecessor product.

13. The computer-readable storage medium of claim 8, wherein the items comprise one or more of raw materials, sub-assemblies, intermediate assemblies, sub-components, and parts, and quantities of each needed to manufacture a finished product represented by a respective BOM.

14. The computer-readable storage medium of claim 8, wherein the attributes comprise one or more of brand, product group, product family.

15. A system, comprising:
a computing device; and
a computer-readable storage device coupled to the computing device and having instructions stored thereon which, when executed by the computing device, cause the computing device to perform operations for automatically identifying one or more recommended predecessor products for demand planning, the operations comprising:
receiving a plurality of bills of material (BOMs), each BOM comprising a data structure defining items within a respective product;
enhancing each BOM based on one or more attributes to provide enhanced BOMs;
clustering the enhanced BOMs into two or more clusters;
determining a matching cluster from the two or more clusters at least partially based on a BOM of a new product introduction (NPI);
selecting a sub-set of predecessor products from the matching cluster; and
providing the sub-set of predecessor products as the one or more recommended predecessor products for selection by a user.

16. The system of claim 15, wherein clustering comprises providing representations of each enhanced BOM as a multi-dimensional vector, and processing the multi-dimensional vectors using a classification algorithm to provide the two or more clusters.

17. The system of claim 15, wherein determining a matching cluster comprises determining a cluster center for each cluster, and comparing cluster centers to the NPI at least partially based on the BOM of the NPI.

18. The system of claim 15, wherein selecting a sub-set of predecessor products comprises at least one of determining similarities between predecessor products of the sub-set of predecessor products and the NIP, and applying one or more filters to predecessor products of the sub-set of predecessor products.

19. The system of claim 15, wherein the NPI comprises a product that is without a predecessor product.

20. The system of claim 15, wherein the items comprise one or more of raw materials, sub-assemblies, intermediate assemblies, sub-components, and parts, and quantities of each needed to manufacture a finished product represented by a respective BOM.
